(19) United States
(12) Patent Application Publication
(10) Pub. No.: US 2023/0242374 A1
(43) Pub. Date: Aug. 3, 2023

(54) METHOD FOR OPERATING A PASSENGER TRANSPORT SYSTEM BY RELIABLY CONFIGURING AN ELECTRONIC SAFETY DEVICE BY MEANS OF VISUAL DATA TRANSMISSION

(71) Applicant: Inventio AG, Hergiswil (CH)

(72) Inventors: David Michel, Rotkreuz (CH); Martin Pfister, Luzern (CH)

(21) Appl. No.: 18/001,481

(22) PCT Filed: May 31, 2021
(86) PCT No.: PCT/EP2021/064508

§ 371 Date: Dec. 12, 2022

(30) Foreign Application Priority Data
Jun. 19, 2020 (EP) 20181073.6

(51) Int. Cl. B66B 1/34; B66B 5/00

(52) U.S. Cl. CPC B66B 1/3407; B66B 5/0031; B66B 5/0087

(57) ABSTRACT

A controller controls passenger transport system functionalities and a safety device monitors a safety-relevant function of the system by storing a configured parameter to transfer to a “configured” state. The method includes: the controller receiving a configuration parameter; transmitting the configuration parameter to the safety device; storing a configured parameter in the safety device, based upon the received configuration parameter; transmitting configured data from the safety device to the controller, the configured data encoding an item of graphic information that is shown on a display of the controller, the graphic information uniquely reproducing the configured parameter in a visual, machine-readable manner; reading out the graphic information by an optical read-out sensor of a mobile, processor-controlled data processing device; and comparing the configured parameter reproduced by the read-out graphic information to a target configuration parameter. The controller controlling the functionalities according to whether there is sufficient agreement between the compared parameters.

### FIELD

The present invention relates to a method for operating a passenger transport system.

### BACKGROUND

Passenger transport systems such as elevators, escalators, or moving walkways are used as devices fixedly installed in buildings for transporting persons and/or objects.

Embodiments of the invention are described below predominantly with reference to a passenger transport system designed as an elevator system. However, the described embodiments can also be implemented for other types of passenger transport systems.

Passenger transport systems generally have to satisfy high safety requirements. For this purpose, several safety devices are typically provided in passenger transport systems, with the aid of which safety-relevant functions of the passenger transport system can be monitored in a controlled, i.e., actively-controlled or at least passively-controlled, manner. Such safety-related functions can comprise, for example, measurement processes by means of which a current state or current conditions within the passenger transport system can be determined, such that information obtained in the process can be taken into account when operating the passenger transport system.

For example, a safety device in the form of a door sensor or door switch in an elevator system can be used to determine whether an elevator door is correctly closed, such that an elevator controller can decide whether an elevator car may be moved on the basis of the information which is transmitted by several such safety devices to different elevator doors of the elevator system, or whether this is not permissible on account of the fact that at least one elevator door is not correctly closed.

Other safety devices can be configured to provide information on the current position of an elevator car in an elevator shaft and/or how quickly the elevator car is currently moving through the elevator shaft. For this purpose, for example, a sensor can be moved together with the elevator car through the elevator shaft, and can read location information presented stationarily within the elevator shaft from which the current position of the elevator car and the current speed of the elevator car can then be inferred. Based upon this information, an elevator controller can move the elevator car precisely to desired positions.

Another type of safety device can be used to detect whether an elevator car is located within a tolerance range above and below a stop position at a floor. Based upon this information, the elevator controller can decide, for example, that elevator doors can be opened before the elevator car has actually reached an intended stop position, i.e., while the elevator car is still moving within the tolerance range (so-called pre-opening). In addition, an elevator controller can, in violation of an otherwise applicable rule that the elevator car must not be moved as long as an elevator door is not completely closed, permit a slow movement of the elevator car as long as the elevator car is located within the tolerance range around the stop position, in order to be able to bring about, for example, a level adjustment (so-called re-leveling) when passengers enter or leave the elevator car, and the load and ultimately the position of the elevator car are changed as a result.

In modern passenger transport systems, the safety devices can be adapted to certain situation-specific and/or system-specific operating conditions and/or properties of the passenger transport system. Such safety devices can thus be referred to as configurable safety devices. For this purpose, the safety devices can be configured, by inputting configuration parameters, to be in a state in which they monitor the function to be monitored by them according to certain specifications. Such a state is hereafter referred to as the “configured” state, and the parameters to be stored to achieve this “configured” state are referred to herein as configured parameters. Before a safety device has been set into the “configured” state, by virtue of the input, in a situation-specific or system-specific manner, of the configured parameter required by it, the safety device must not be operated in the passenger transport system, such that the entire passenger transport system is not yet ready for operation.

In modern passenger transport systems, safety devices are increasingly implemented using electronic and/or programmable circuits. On the one hand, this can lead to the safety devices being able to adapt to different operating conditions and/or environmental conditions, because they can be adapted individually, e.g., by storing system-specific and/or situation-specific configured parameters, for the purpose of monitoring the functions to be monitored by them in a prespecified manner. In this case, the safety devices can operate in a particularly reliable manner, be cost-effective, and/or be easily maintained. On the other hand, it can be a challenge to ensure that the configured parameters used for programming the safety devices are correct.

WO 2019/011828 A1 describes a method for configuring safety-relevant configuration parameters in a passenger transport system.

WO 2017/220678 A1 describes a method for configuring a passenger transport system with a mobile, processor-controlled data processing device in the form of a mobile terminal.

### SUMMARY

Among other things, there may be a need for an alternative approach to enabling the configuration of safety devices in passenger transport systems in the simplest possible, and nevertheless reliable, manner.

Such a need can be met by the subject matter of the advantageous embodiments are defined in the following description.

According to the invention, a method for operating a passenger transport system is proposed. The passenger transport system has a controller for controlling functionalities of the passenger transport system, and at least one safety device for monitoring a safety-relevant function of the passenger transport system. By storing at least one configured parameter, the safety device can be transferred into and/or configured to be in a “configured” state, to monitor the safety-relevant function according to certain specifications. The method has at least the following steps—preferably in the order provided:

receiving a configuration parameter by the controller;

transmitting the configuration parameter to the safety device;

storing a configured parameter in the safety device, based upon the received configuration parameter, to transfer the safety device into or configure it to be in the “configured” state;

transmitting configured data from the safety device to the controller,

wherein the configured data encode graphic information,
wherein the graphic information is shown on a display connected to the controller, and
wherein the graphic information uniquely reproduces the configured parameter in a visual, machine-readable manner;

reading out the graphic information by means of an optical read-out sensor of a mobile, processor-controlled data processing device; and

comparing the configured parameter reproduced by the output graphic information to a target configuration parameter with the aid of the data processing device;

transmitting a result of the comparison from the data processing device to the controller.

The controller controls the functionalities of the passenger transport system according to whether a sufficient agreement between the configured parameter and the target configuration parameter was determined during the comparison.

Possible features and advantages of embodiments of the invention can be considered, inter alia and without limiting the invention, to be based upon the concepts and findings described below.

As already stated briefly, modern passenger transport systems generally have several safety devices, in order to be able to monitor safety-relevant functions and thus ensure safe operation of the passenger transport system. The safety devices are individually configurable in order to be customized to the properties of the individual passenger transport system and/or operating conditions prevailing there. At least one of these individualized configurations of the safety device is carried out when the safety device to be configured is already installed in the passenger transport system in its final position.

Before the passenger transport system is put into operation, its safety devices must be configured correctly. In the conventional approach, suitable configuration parameters for each safety device are individually created, and then transmitted to the respective safety devices. The respective configuration parameters can be entered, for example, at a human/machine interface by a technician. The human/machine interface can correspond, for example, to the elevator controller, or be integrated therein. Alternatively, the configuration parameters can be retrieved, for example, from the elevator controller or a device connected thereto—for example, from an electronic data source. The configuration parameters are then sent by the elevator controller to the respective safety devices. The safety device stores the received configuration parameters and can subsequently be operated with the corresponding configuration. In order to be able to verify whether the safety device has received and stored the correct configuration parameters, it can be provided that the configuration parameters be transmitted from the safety device back to the elevator controller or the human/machine interface connected thereto. There, the configuration parameters transmitted back can then be verified by the technician and/or compared with target values.

However, it has been recognized that errors can occur in the above-described configuration process. For example, in the case of a data transmission from the human/machine interface to the elevator controller and/or from the elevator controller to the safety device, it may happen that the data to be transmitted, inadvertently, or due to a systematic error, are modified such that the data which actually reach the safety device contain errors.

In the worst case, in the data transmission to the safety device, and the subsequent return of data back to the elevator controller or the human/machine interface, systematic errors can occur in such a way that modifications of the data carried out during the data transmission on the outbound route are subsequently compensated for in the return transmission of the data back to the elevator controller or the human/machine interface, and therefore cannot be recognized by a monitoring technician, for example.

In order to be able to eliminate the described deficits of conventional configuration processes, in particular, an approach for the method proposed herein is described in shortened form, in which a first data transmission, by means of which configuration parameters received by the controller of the passenger transport system are transmitted to the safety device, and a second data transmission, by means of which configured parameters stored in the safety device are transmitted back to the controller, differ from one another. Whereas, during the first data transmission, an electrical signal which reproduces, for example, a value of the configuration parameter to be transmitted, can be transmitted by the controller to the safety device, during the second data transmission, graphic information is created, at least as an intermediate step, as a visual reproduction of the configured parameter to be transmitted. This graphic information is shown on a display, from which it can then be read out by means of a read-out sensor of a mobile data processing device. The configured parameter which is visually transmitted in this way by the graphic information can ultimately be compared with a target configuration parameter, and functionalities of the passenger transport system can then be permitted by the controller only if both parameters correspond sufficiently. The comparison can be carried out by a technician to whom the transmitted configured parameter and the target configuration parameters are displayed by the data processing device, who enters the result of the comparison in the data processing device. Alternatively, the comparison can be carried out by the data processing device itself, which is programmed accordingly. In both examples, the comparison is carried out with the aid of the data processing device. After conclusion of the comparison, the data processing device transmits the result of the comparison, i.e., whether the parameters correspond sufficiently within an acceptable tolerance, to the controller.

Due to the fact that data are transmitted in a different manner from the safety device on a forward path than on a return path back from the safety device, the intended result is, in particular, that the data are not subjected to the same or inverse data processing on the outbound path and the return path. Ultimately, this is intended to prevent the data from being modified or transmitted with errors in the two, oppositely-directed, data transmission paths. Instead, it is intended that, if one of the two data transmissions should be modified or contain errors, these errors will not be compensated for, at least due to the fact that, in the other data transmission, a different type or technology is used for transmitting the data during the opposite data transmission, and could thus remain undetected.

Details and possible embodiments of the data transfers to be carried out within the scope of the method proposed herein and other method steps are discussed below.

First, at least one configuration parameter is received by the controller. As explained in more detail below with reference to various embodiments, configuration parameters can originate from different data sources and/or can be provided to the controller via different paths.

The received configuration parameter is then transmitted to the safety device. Typically, at least one, dedicated data transmission channel exists between the controller and the safety device, via which the two components can exchange data. A data transmission channel is defined by an interaction of a physical data transmission medium, such as a data cable or a data radio link, on the one hand, and a data protocol, used in the data transmission, which specifies the manner in which information to be transmitted with the data should be encoded. For example, a data interface of the controller can be wired directly to a data interface of the safety device via a data cable. The cabling can be part of a bus system. Alternatively, the two components can exchange data wirelessly—for example, via a radio link. Measures such as data encryption and/or an authentication of the communications partners can be established in order to ensure security of data transmission. The configuration parameter can be transmitted, for example, as an electrical signal via the data transmissions channel. The electrical signal can, for example, encode a value or other properties of the configuration parameter in a digital or analog manner.

After the safety device has received the configuration parameter, it can store it, or can store a parameter corresponding to the received configuration parameter or derived from the received configuration parameter, as a configured parameter. As a result, the safety device transitions into its “configured” state, such that it can subsequently monitor the safety-relevant functions to be monitored by it in a correct manner.

In order to subsequently check whether the safety device has been configured with a correct configuration parameter, data which indicate the configured parameter are then transmitted from the safety device back to the controller. Ultimately, the configured parameter is intended to be relayed by the controller to a mobile data processing device, where it can be compared with a target configuration parameter—for example, after it has been output in a manner perceivable by a technician.

However, the data transmission channel mentioned above, via which the configuration parameter was sent from the controller to the safety device, is not to be used for this purpose. Instead, a further data transmission channel is to be used for this purpose. This further data transmission channel may possibly use the same physical data transmission medium, i.e., for example, the same data cable, for a data transmission from the safety device to the controller as was previously used in the data transmission in the reverse direction from the controller to the safety device. However, the data protocol used in this case, i.e., the manner in which the configured parameter is encoded for the data transmission, is to differ from the data protocol in the data transmission in the reverse direction.

Specifically, the configured data is to encode graphic information. In this case, graphic information is understood to mean a data reproduction in which the configured parameter is reproduced in a visual manner that is readable for a machine. For example, a value and/or another property of the configured parameter can be reproduced using a barcode, a 2-D code (two-dimensional code), or the like. The 2-D code can be embodied in different ways—for example, as a QR code, a data matrix code, or as a similar code.

In this case, the graphic information is intended to reproduce the configured parameter without ambiguity. This means that graphic information may be interpreted only as a single, configured parameter value or a single, configured parameter property, to so to rule out misinterpretations or misunderstandings.

The graphic information created in this way and transmitted to the controller can then be shown on a display. The display can also be referred to as a screen. This display is connected to the controller. For example, the display can be integrated into a housing accommodating the controller. Alternatively, the display can be wired to the controller as a separate component, or can wirelessly exchange data. The display can also be used by the controller for other tasks. In particular, the display can serve as a human/machine interface in order, for example, to output information from the controller to a person, such as a technician performing maintenance on the elevator system. The display can be touch-sensitive, i.e., can be designed as a touchscreen, such that it can also serve as a human/machine interface by means of which data can be transmitted from a person to the controller.

The graphic information can subsequently be read from the display. This is to take place in particular with the aid of a mobile, processor-controlled data processing device. The data processing device can, for example, be an intelligent telephone (e.g., smartphone), a portable computer (e.g., a laptop), or a similar portable device equipped with a processor for data processing. The data processing device can be carried by an authorized technician, for example. For example, the data processing device can be a smartphone of the technician on which a special application (app) has been installed.

A data transmission between the data processing device and the controller can be realized in this case, at least in one variant of a data transmission channel, by the graphic information shown on the display by the controller being read out by means of the optical read-out sensor of the data processing device, and subsequently processed in the data processing device. The read-out sensor can be configured to detect optical, i.e., visually discernible, features. For example, the read-out sensor can be a camera, a light sensor, a scanner, or the like.

In addition to its processor, the data processing device can also have a data memory, in which data can be stored, and/or can have data interfaces via which data can be exchanged with other devices. Furthermore, the data processing device can have a human/machine interface via which data can be input by a person and/or data can be output in a manner perceptible to the person. The human/machine interface can comprise, for example, a touch-sensitive screen, a loudspeaker, a microphone, and/or a keyboard.

After the graphic information has been read out by the data processing device, the configured parameter reproduced by it can be compared with a prespecified target configuration parameter. If such a comparison reveals that both parameters are sufficiently consistent within an acceptable tolerance, this can be understood by the controller as an indicator that safety-relevant functions of the passenger transport system can be carried out, since the safety device has been correctly transferred into, or configured to be in, its “configured” state. The data processing device then transmits the result of the comparison to the controller.

However, if a sufficient agreement between the visually-read, configured parameter and the target configuration parameter is not found, the controller must not use the data from the non-correctly-configured safety device, such that safety-relevant functions of the passenger transport system influenced thereby may not be activated by the controller.

The controller is thus designed in such a way that it controls the functionalities of the passenger transport system as a function of whether a sufficient agreement was detected between the visually-read configured parameter and the target configuration parameter. This is to be understood as meaning that the controller controls the passenger transport system differently after a sufficient agreement has been detected than it does before the reception. The controller can control the passenger transport system, e.g., before a sufficient agreement is detected, in such a manner that moving parts of the passenger transport system, such as an elevator car of an elevator system, are not moved at all, or only very slowly, i.e., slower than in normal operation of the passenger transport system. Only after a sufficient agreement is detected are moving parts moved at a normal speed. Furthermore, further actuations of the passenger transport system may be considered, depending upon the detection of a sufficient agreement.

The controller is designed in particular in such a manner that it actuates the functionalities of the passenger transport system designed as an elevator system such that an elevator car of the passenger transport system is moved in an elevator shaft only after a sufficient agreement between the visually-read configured parameter and the target configuration parameter has been established. This ensures that the elevator car is moved only after the safety device has been configured. This allows particularly safe operation of the elevator system.

The controller can, in particular, be designed to actuate the functionalities of the passenger transport system to a limited extent, if necessary, before the detection of a sufficient agreement between the visually-read configured parameter and the target configuration parameter, and to actuate the functionalities of the passenger transport system to a full extent after the reception. This limited extent can be referred to, for example, as a startup mode or maintenance mode, and the full extent as a normal mode.

According to a specific embodiment, the data processing device can output the configured parameter reproduced by the graphic information to a person and, upon confirmation of the correctness of the configuration parameter by the person, can transmit a “sealed” signal to the controller. In this case, the controller can be designed to actuate the functionalities of the passenger transport system at most to a limited extent prior to receiving the “sealed” signal, and to actuate the functionalities of the passenger transport system to a full extent after receiving the “sealed” signal.

In other words, the data processing device can be used to enable, for example, an authorized technician to check the configured parameter transmitted by the safety device to the controller, and to further verify the correctness on the data processing device by comparison with the target configuration parameter. For this purpose, the technician can compare the information about the configured parameter that is output by the data processing device with the other information available to it—for example, information about target specifications. It can be provided that the elevator system only be able to be operated in its complete functional range if such a verification has taken place by an authorized technician. In the case of conventional elevator systems, it can be provided for this purpose that the safety device, after it has been verified by the technician, be sealed, i.e., provided with a seal, for example. In the approach described here, a sealing can take place electronically, i.e., the controller can be configured to authorize the complete functional range of the elevator system only when the configured parameter stored and then transmitted by the safety device has been verified by the technician, and its correctness has been confirmed.

For this purpose, the technician can perform an input on the mobile data processing device for confirmation of the correctness, on the basis of which the “sealed” signal is then transmitted to the controller of the elevator system. Only after this “sealed” signal is received does the controller switch from a limited operating mode, in which safety-relevant functionalities of the passenger transport system are permitted to a limited extent, to a normal operating mode in which all safety-relevant functionalities of the passenger transport system are permitted and monitored by the controller.

According to a specific embodiment, the controller can transmit the “sealed” signal to the safety device, wherein the safety device then changes into a sealed state after the reception of the “sealed” signal. The safety device then transmits an “acknowledged” signal to the controller. The controller is provided to actuate the functionalities of the passenger transport system to a limited extent before the reception of the “acknowledged” signal, and to actuate the functionalities of the passenger transport system to a full extent after the reception of the “acknowledged” signal.

As soon as the safety device is in the sealed state, changed configuration parameters can be stored only under elevated security conditions—for example, with the input of a special authorization code in the safety device. Unauthorized changes in the configuration parameters can thus be prevented particularly effectively, which enables particularly safe operation of the passenger transport system. The safety device is in particular designed such that, before a change into the sealed state, it permits operation of the passenger transport system only with restricted functionalities. It is specifically designed in such a way that, before a change into the sealed state, it does not permit, or permits only to a limited extent, a movement of the elevator car in the elevator shaft.

According to one embodiment, the configured data should not be modified by the controller before the presentation on the display.

In other words, the controller is, preferably, not in any way to modify or process the configured data that it receives from the safety device before it forwards the data to the display. Instead, the graphic information which is encoded by the configured data should be presented on the display directly and without being modified beforehand by the controller.

This is intended in particular to prevent the graphic information received by the controller being forwarded to the display with errors, or to prevent errors in the graphic information depicted on the display—for example, due to systematic errors which could occur during data processing within the controller.

According to a further specific embodiment, the graphic information encoded in the configured data can define a state to be assumed for each of a plurality of pixels of the display.

In other words, the display can have a matrix made of a plurality of pixels. Each of the pixels can be activated individually. For example, a variable electrical voltage can be applied to a single pixel. Depending upon the manner of activation and/or the applied voltage, the pixel can assume a display state, i.e., it can assume, for example, a degree of brightness, dependent upon the activation, and/or a color dependent upon the activation. Optionally, the display can have its own control electronics, which convert input signals, e.g., in the form of graphic information, into control signals for each of the plurality of pixels.

In this case, the configured data transmitted by the safety device to the controller can already encode graphic information such that it can be displayed directly by the display, i.e., without the controller having to process these data beforehand. In particular, the configured data can encode graphic information in a way which allows the control electronics of the display to immediately and clearly convert them into the activation state of each of the pixels of the display.

As a result, possible error sources during the data transmission between the safety device, on the one hand, and the mobile data processing device in which the comparison of the transmitted configured parameter with the target configuration parameter is to take place, on the other, can be minimized.

According to one embodiment, several configured data can be transmitted to the controller one after the other by the safety device. Each of the several configured data can encode a different item of graphic information. Each of the several graphic information items is then displayed on the display connected to the controller. Each of the graphic information items clearly represents the configured parameter in a visual, machine-readable manner.

In other words, the safety device can transmit the information regarding the configuration parameters to the controller, and then further to the mobile data processing device, not just with the aid of a single set of configured data. Instead, several configured data can be transmitted by the safety device. Although each of these configured data can reproduce the same value or the same property of the configuration parameter stored for the configuration of the safety device, each item of this information can, however, encode this information in another manner as graphic information. In other words, for example, one and the same value of a configuration parameter can be reproduced with different bar codes or 2-D codes. These different graphic information items can then be displayed on the display.

In principle, the various graphic information items can be displayed simultaneously in different areas of the display. However, the displays typically used for passenger transport systems are relatively small and have a matrix with relatively few pixels. Therefore, it may be preferred to display the various graphic information items on the display sequentially.

By displaying the configured parameter using several different graphic information items, it is possible, inter alia, to avoid a faulty transmission of the configured parameter between the controller and the mobile data processing device as the result of pixel errors in the display used for the visual output. Due to pixel errors, individual pixels of the display may not correctly assume a state defined in the graphic information. An incorrectly assumed state can lead to the graphic information read out by the read-out sensor of the mobile data processing device not correctly corresponding to the graphic information created by the safety device, and thus to faulty data being transmitted between the two components. However, by the configured parameter being transmitted with several different graphic information items, such a faulty data transmission caused by pixel errors can be detected. If necessary, appropriate error messages can be output on the mobile data processing device, and/or error correction measures can be undertaken.

According to one embodiment, several partial information items, each encoding partial information of a graphic information item, can be displayed sequentially on the display connected to the controller. A sum of the partial information clearly represents the configured parameter in a visual, machine-readable manner. The configured data packets can be transmitted to the controller one after the other by the safety device. Alternatively, it is also possible for the controller to divide the configured parameter received by the safety device into the individual, configured data packets.

As already indicated above, a display available to the controller may have only a relatively small matrix of pixels. Due to the small number of pixels available therein, it may be difficult or even impossible to display simultaneously an entire set of configured data on the display using a single item of graphic information. In order to still be able to represent the entire data set, the data set can be subdivided into several data packets. Each of these data packets can encode part of the complete graphic information to be transmitted. The several partial information items of the graphic information can then be displayed successively on the display and read out by the read-out sensor of the mobile data processing device. The partial information can, for example, be presented on the display as several still images to be displayed in succession. Alternatively, the partial information can also be presented continuously by the display. As soon as the data processing device has read out all the partial information items, it can deduce the complete graphic information item, and the configured parameter to be transmitted, from the sum of these partial information items.

According to one embodiment, the controller may receive the configuration parameter due to a manual input to be performed by a person at a human/machine interface.

In other words, the configuration parameter to be received by the controller can be obtained as the result of a person, such as an authorized technician, entering this configuration parameter on a human/machine interface. Such a human/machine interface can be an integral part of the controller. Alternatively, the human/machine interface can be provided as a separate device and can, for example, be temporarily or permanently coupled to the interface.

The human/machine interface can have an input device via which the person can input data which reproduce the configuration parameters. For this purpose, the human/machine interface can have a keyboard, a touch-sensitive screen, or the like. In addition, the human/machine interface can have an output device in order to be able to output data in a manner perceivable to the person. For this purpose, for example, a screen, a loudspeaker, or the like can be used. For example, the display described above, which displays the graphic information, can serve as the human/machine interface.

As part of a configuration process, the person can thus transmit the configuration parameter to the controller via the human/machine interface.

According to one embodiment, the controller can receive the configuration parameter from a mobile, processor-controlled data processing device, which can be temporarily coupled to the controller for data exchange.

In other words, the controller can at least temporarily be coupled to a mobile, processor-controlled data processing device, and receive configuration parameters from it.

After its coupling to the controller, the data processing device can serve as a human/machine interface for the controller. For example, data which reproduce the configuration parameter can be input by a person into the data processing device—for example, by means of its keyboard or its touch-sensitive screen. These data can then be forwarded to the controller.

Alternatively or additionally, the data processing device can serve to retrieve data which reproduce the configuration parameter, e.g., from a remote database, and then relay it to the controller.

Alternatively or additionally, according to one embodiment, the controller can receive the configuration parameter by retrieving data from a remote database.

In other words, one of the independently created parameters can be obtained by being retrieved from a database. The database can be stored remotely from the controller, and in particular also remotely from the entire passenger transport system—for example, on a server or in a data cloud. The controller or a device communicating with it can be connected to this database for data transmission—for example, by wired or wireless data transmission.

According to a specific embodiment, in the database, data can be retrieved which were created in a design process and/or during a commissioning of the passenger transport system, and which contain the configuration parameters or from which the configuration parameters can be derived.

In other words, the configuration parameter to be received by the controller can be created based upon data which have previously been created during the design of the passenger transport system or a commissioning of the passenger transport system. In such a design or commissioning, the safety devices to be installed in the passenger transport system are also typically selected and planned with respect to their configuration. Accordingly, detailed information about a target configuration of the individual safety devices of the passenger transport system can be found in the data produced during this process. These data are typically stored in databases, e.g., at a manufacturer of the passenger transport system and/or of the safety devices, and can thus be retrieved by the controller if necessary.

According to a further embodiment, the controller can receive the configuration parameter from a data memory which is coupled to the controller for data exchange.

In contrast to the data processing device described above, the data memory itself need not have data processing capability, i.e., it does not require its own processor. Instead, the data memory can simply store data and make it available to the controller for retrieval when necessary. In contrast to the data processing device, the data memory usually also has no power supply of its own. The data memory can be a volatile or non-volatile memory. For example, the data memory can be a flash memory—for example, in the form of a SIM card or SD card.

The data stored on the data memory can reproduce configuration parameters. In this case, these data may have been generated independently of data reproduced from configuration parameters, which data are provided to the controller via other channels. For example, the data stored in the data memory may have been determined and stored in advance by a manufacturer of the safety device or a manufacturer of the controller.

After the safety device has received the configuration parameter transmitted to it by the controller, and, on the basis thereof, has stored the configuration parameter, the safety device can transmit the configured parameter back to the controller as a confirmation of this storage of the configured parameter, and for the purpose of verifying the configured parameter, whereupon the controller forwards it to the mobile data processing device. The re-transmitted, configured parameter can then be analyzed to determine, for example, whether it corresponds to prespecified target specifications. This can take place, for example, within or with the aid of the mobile data processing device temporarily coupled to the controller.

For this purpose, the data processing device can serve, for example, as a human/machine interface in order to output, for example, the transmitted configured parameter in a manner perceivable by the technician. The technician can then compare the configured parameter with the target configuration parameter known to him. Alternatively, the data processing device can use its data communication interfaces in order to transmit the received configured parameter to external devices, such as, for example, a monitoring device for monitoring functionalities of the elevator system. There, the configured parameter can be compared with the there known target configuration parameter.

The configuration parameter is transmitted—in particular, together with a checksum characterizing the configuration parameter—from the controller to the safety device.

In other words, the configuration parameter is preferably not transmitted solely as data between the controller and the safety device; rather, the data reproducing the configuration parameter are supplemented by data which reproduce a checksum characterizing the configuration parameter.

Such a checksum can be used as part of a cyclic redundancy check, and is therefore sometimes also referred to as a CRC. The cyclic redundancy check is a method in which a check value for data is determined, so as to make it possible to detect errors in a transmission or storage of the data. In the ideal case, even received data can be automatically corrected in the method in order to prevent another transmission. Prior to the data transmission or data storage, for example, an additional redundancy in the form of a so-called CRC value is added for a data block of payload data. The CRC value acts as a checksum, and is a check value calculated according to a specific method, with the aid of which any errors occurring during storage or transmission can be detected. Accordingly, by adding the checksum characterizing the configuration parameter, a risk of undetected errors occurring during the transmission of the configuration parameter from the controller to the safety device can be minimized.

In this case, the controller can be designed to exchange signals or data with different actuators and/or sensors within the passenger transport system. In particular, the controller can control an operation of a drive machine of the passenger transport system. The controller can optionally also accept inputs from various human/machine interfaces in order, on the basis thereof, to control the operation of the passenger transport system, or to output information relating to a current state of the passenger transport system via human/machine interfaces. For example, such human/machine interfaces can comprise buttons, keys, sensors, screens, loudspeakers, and/or the like on operating panels of an elevator system. The controller can have, for example, individual modules communicating with one another, wherein, for example, one module perceives safety-relevant tasks, and another module operates the human/machine interfaces and actuates the drive machine.

The safety device can be designed to monitor a safety-relevant function within the passenger transport system. For this purpose, the safety device can have one or more sensors in order to be able to detect physical variables which correlate with the safety-relevant function. The safety device may also have one or more actuators with which such physical variables can be influenced.

For example, safety devices can be designed to detect a current opening state of an elevator door, to measure a current travel speed of an elevator car, to determine a current location of the elevator car within an elevator shaft, to detect a load or acceleration currently acting on the elevator car, or the like.

By storing the configured parameter, the safety device can be adapted to properties of the passenger transport system and/or to conditions prevailing in the passenger transport system.

Embodiments of the invention will be described below with reference to the accompanying drawings, wherein neither the drawings nor the description are intended to be interpreted as limiting the invention.

### DESCRIPTION OF THE DRAWINGS

FIG. 1 shows an elevator system according to an embodiment of the present invention.

FIG. 2 is a diagram for illustrating data transmission and data processing as part of a method according to one embodiment of the present invention.

The drawings are merely schematic, and not to scale. Like reference signs denote like or equivalent features in the various drawings.

### DETAILED DESCRIPTION

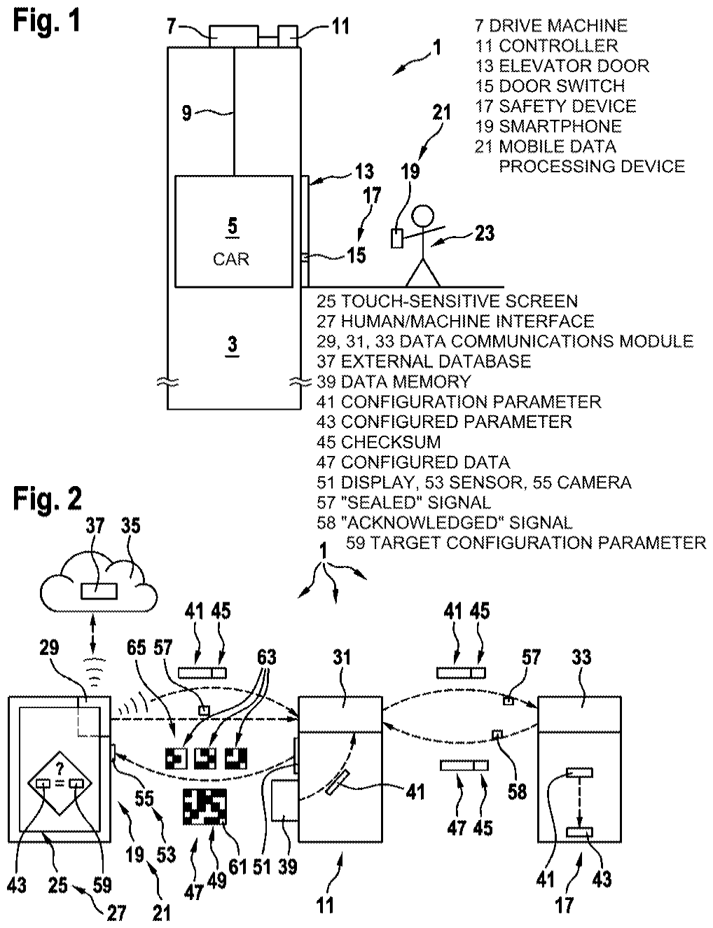

FIG. 1 shows a passenger transport system 1 in the form of an elevator system. An elevator car 5 is arranged in an elevator shaft 3 and is held by cable-like traction means 9. A drive machine 7 can move the cable-like traction means 9 and thus move the elevator car 5 vertically. The drive device 7 is controlled by a controller 11. The controller 11 can have, for example, individual modules communicating with one another, wherein, for example, one module perceives safety-relevant tasks, and another module operates a human/machine interface and actuates the drive machine 7. An elevator door 13 is provided at a floor. A currently closed state of the elevator door 13 is monitored by a safety device 17 in the form of a door switch 15. Several further safety devices 17 can also be provided in the passenger transport system 1 in order to monitor, for example, closing states of further elevator doors 13, or also other functionalities.

A technician 23 can visit the passenger transport system 1 in order to configure the passenger transport system 1 and, in particular, its safety device 17 with his smartphone 19 as a mobile data processing device 21. This can take place, for example, directly after completion of the passenger transport system 1, or also during maintenance of the same.

A possible embodiment of such a process for configuring the safety device 17 is described with reference to FIG. 2.

First, the controller 11 receives a configuration parameter 41. The configuration parameter 41 specifies a desired configuration of the safety device 17 to be configured.

In the example shown, the configuration parameter 41 is transmitted from the mobile, processor-controlled data processing device 21 to the controller 11. The data processing device 21 can be the smartphone 19 of the technician 23 on which a suitable application (app) runs. The configuration parameter 41 can, for example, be input by the technician 23 via a human/machine interface 27 of the smartphone 19. The human/machine interface 27 can, for example, be a touch-sensitive screen 25 or a keyboard. Alternatively, the configuration parameter 41 can also be retrieved by means of a data communications module 29 of the smartphone 19 from an external source such as, for example, an external database 37 maintained in a data cloud 35. In the database 37, for example, configuration data can be stored which have been created during a design process or during a commissioning of the passenger transport system 1. The configuration parameter 41 can then also be transmitted, for example, by means of the data communication module 29 to the controller 11 and/or its data communications module 31. For example, the data transmission can take place wirelessly.

Alternatively, the communication parameter 41 can be provided by a data memory 39 which is coupled to the controller 11 for data exchange. This data memory 39 can, for example, be a flash memory on which configuration data for all safety devices 17 of the passenger transport system 1 are stored.

From the controller 11, the configuration parameter 41 is then transmitted further to the safety device 17 or to the data communications module 33 thereof. In the safety device 17, a configured parameter 43 is then stored based upon the received configuration parameter 41, in order to transfer the safety device 17 into its “configured” state as a result.

Subsequently, configured data 47 are generated in the safety device 17, based upon the configured parameter 43. These configured data 47 encode graphic information 49, which uniquely reproduces the configured parameter 43 in a visually displayable and machine-readable manner. For each pixel 61 of a display on which the graphic information 49 is to be displayed, the graphic information 49 indicates a state to be assumed by the pixel 61.

The configured data 47 are then transmitted from the safety device 17 back to the controller 11, and then forwarded from the latter to the data processing device 21. In this case, a different data transmission channel is used than in the preceding data transmission from the data processing device 21 via the controller 11 to the safety device 17.

For this purpose, the controller 11 has a small display 51—for example, in the form of an LCD display, and in particular in the form of a matrix display. If necessary, the display 51 can also be provided externally, and the controller 11 can be connected to this external display 51. The display 51 can be used by the controller 11 during normal operation of the elevator system 1, for example, to indicate a current functional status of the elevator system 1 or components of the elevator system 1.

In the context of the configuration method described herein, the controller 11 can use the display 51 to display the graphic information 49, received by the safety device 17, on the display 51. The graphic information 49 defines, for each of the pixels 61 of the display 51, the state to be assumed. The graphic information 49 (shown roughly schematically in FIG. 2 as a plan view of a 2-D code) shown, for example, in a manner similar to a bar code or a 2-D code can then be recognized and read out by an optical read-out sensor 53 of the mobile data processing device 21. The read-out sensor 53 can, for example, be a camera 55 of the smartphone 19 acting as a data processing device 21.

If the display 51 has only relatively few pixels 61, the complete graphic information 49 can also be divided into several partial information items 63 (as also shown in FIG. 2 as an alternative). The various visually displayed, partial information items 63 are reproduced by several configured data packets 65 which, in total, reproduce the configured parameter 43. Each of the partial information items 63 specifies the state for each of the small number of pixels 61. The configured data packets 65 can be transmitted by the safety device 17 one after the other to the controller 11 (not shown). Alternatively, the controller 11 can divide the configured parameter received by the safety device 17 into the individual, configured data packets. The several partial information items 63 are displayed in succession on the display 51. The read-out sensor 53 of the data processing device 21 can then successively read out this partial information 63 and determine the configured parameter 43 from its sum.

In a further optional embodiment, the configured parameter 43 can be reproduced by a plurality of differently configured data 47. Each of these configured data 47 encodes the configured parameter 43 with a different item of graphic information 49. The various items of graphic information 49 can then preferably be displayed in succession on the display 51 and read out by the read-out sensor 53. If defective pixels 61 exist on the display 51, they could interfere with the transmission of individual items of the graphic information 49. However, the probability of such pixel errors falsifying all successively transmitted graphic information 49 is low. Accordingly, a secure visual transmission of the configured data 47 can be achieved by analysis of the different items of graphic information 49, even in the presence of pixel errors.

The configured data 47 transmitted in this way by the controller 11 to the data processing device 21 visually, and/or the configured parameter 43 reproduced by the data, can subsequently be compared with a target configuration parameter 59.

For this purpose, the configured parameter 43 can be displayed, for example, on the screen 25 of the smartphone 19 to the technician 23 on the basis of the configured data 47. The technician 23 can know the target configuration parameter 59 and can verify whether the configured parameter 43 matches the target configuration parameter 59 within acceptable tolerances. Alternatively, for example, the target configuration parameter 59 can also be stored in the smartphone 19 or retrieved from the smartphone 19, for example, from the database 37, and also displayed on the screen 25. The technician 23 can then compare the configured parameter 43 even more easily with the target configuration parameter 59.

With sufficient agreement of both parameters 43, 59, the technician 23 can, for example, grant an authorization by actuating a control panel on the touch-sensitive screen 25 designed as a human/machine interface 27, which authorization is transmitted to the controller 11. The authorization can be regarded as a result of the comparison of the two parameters 43, 59. In response to this authorization, the data processing device 21 can send a “sealed” signal 57 to the controller 11. Only when the controller 11 receives such a “sealed” signal 57 can it reliably assume that the safety device 17 has been correctly configured, and can then actuate the complete range of functionalities of the passenger transport system 1 in a normal mode. Before receiving the “sealed” signal 57, the controller 11 can, on the other hand, be operated only in a restricted mode, in which functionalities of the passenger transport system 1 are, at most, limited.

Instead of transitioning directly to the normal mode after receiving the “sealed” signal 57 from the data processing device 21, the controller 11 can transmit the “sealed” signal 57 to the safety device 17. After the reception of the “sealed” signal 57, the safety device 17 then changes into a sealed state, and transmits an “acknowledged” signal 58 to the controller 11. The controller 11 enters the normal mode only after receiving the “acknowledged” signal 58 from the safety device 17.

In order to ensure the integrity of the data which reproduce the configuration parameters 41 and/or the configured data 47, for the transmission between the different devices, i.e., between the data processing device 21 and the controller 11, on the one hand, or between the controller 11 and the safety device 17 on the other, checksums 45 which characterize the configuration parameter 41 or associated configured data 47 can additionally be transmitted. Such checksums 45 can have been determined in advance as CRC values.

In the example described above, the configuration parameter 41 was determined by the mobile data processing device 21 and transmitted to the controller 11. For example, the data processing device 21 can recognize an input from the technician 23 on its screen 25 as a configuration parameter 41, or determine data retrieved from the database 37 as configuration parameters 41. Alternatively, the configuration parameter 41 can be read out from the data memory 39 provided directly on the controller 11. As a further alternative, it is also conceivable to allow the configuration parameter 41 to be determined directly by the controller 11 by, for example, retrieving data from a database 37 via the data communication module 31 integrated into the controller 11, and receiving it as a configuration parameter 41.

In particular, it is possible with the aid of the method proposed herein to carry out a configuration of the safety device 17 without the technician 23 having to manually enter configuration data into a human/machine interface. For example, in the data processing device 21, the configuration parameter 41, which has been read out in an automated manner from the database 37, can be automatically compared with the configured parameter 43 returned by the safety device 17. If both parameters 41, 43 match, the “sealed” signal 57 can be transmitted to the controller 11. An authorization by the authorized technician 23 may possibly be required before the transmission of the “sealed” signal 57—for example, by operating a control panel on the screen 25 of the smartphone 19.

As soon as the configured parameter 43 is stored, the safety device 17 can transition into its “configured” state, and thus at least into a partial operation in which its functionalities are available at least to a limited extent, and/or in which functionalities of the entire passenger transport system 1 are available to a limited extent. In partial operation, for example, a speed with which the elevator car 5 may be displaced can be limited, or travel of the elevator car 5 can be carried out only after prior additional confirmation. At a later point in time, the stored configured parameter 43, for example, can then be checked by a technician 23 after transmission to his smartphone 19, and, in the event it is correct, the “sealed” signal 57 can be transmitted to the controller 11, whereupon it can then transition to full operation.

Overall, with the approach described herein, greater reliability in the configuration of the passenger transport system 1, and thus increased safety for the passenger transport system 1, can be achieved. Furthermore, the configuration itself can be simplified.

Finally, it should be noted that terms such as “comprising,” “having,” etc., do not exclude other elements or steps, and terms such as “a” or “an” do not exclude a plurality. Furthermore, it should be noted that features or steps which have been described with reference to one of the above embodiments may also be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-13. (canceled)

14. A method for operating a passenger transport system, the passenger transport system having a controller controlling functionalities of the passenger transport system and a safety device for monitoring a safety-relevant function of the passenger transport system, wherein the safety device is transferred into a “configured” state by storing a configured parameter and then monitors the safety-relevant function according to predefined specifications, the method comprising the steps of:
receiving a configuration parameter using the controller;
transmitting the configuration parameter from the controller to the safety device;
storing a configured parameter in the safety device, the configured parameter based upon the received configuration parameter, thereby transferring the safety device into the “configured” state;
transmitting configured data from the safety device to the controller, wherein the configured data encodes graphic information;
showing the graphic information on a display connected to the controller, wherein the graphic information uniquely reproduces the configured parameter in a visual, machine-readable manner;
reading out the graphic information using an optical read-out sensor of a mobile, processor-controlled data processing device;
comparing the configured parameter reproduced by the read-out graphic information with a target configuration parameter using the data processing device;
transmitting a result of the comparison from the data processing device to the controller; and
wherein the controller controls the functionalities of the passenger transport system when a predetermined sufficient agreement between the configured parameter and the target configuration parameter is determined by the comparison.

15. The method according to claim 14 wherein the controller actuates the functionalities of the passenger transport system being an elevator system such that an elevator car of the elevator system is only moved in an elevator shaft after the predetermined sufficient agreement between the configured parameter and the target configuration parameter has been established during the comparison.

16. The method according to claim 14 wherein the data processing device outputs the configured parameter reproduced by the read-out graphic information to a person and, upon confirmation of the configured parameter by the person, transmits a “sealed” signal to the controller, wherein, prior to receiving the “sealed” signal, the controller actuates the functionalities of the passenger transport system at most to a limited extent, and, after receiving the “sealed” signal, actuates the functionalities of the passenger transport system to a full extent.

17. The method according to claim 16 wherein the controller transmits the “sealed” signal to the safety device, the safety device, upon receiving the “sealed” signal, switches to a sealed state and transmits an “acknowledged” signal to the controller, and the controller actuates the functionalities of the passenger transport system, before a reception of the “acknowledged” signal, at most to the limited extent and, after the reception of the “acknowledged” signal, activates the functionalities of the passenger transport system to the full extent.

18. The method according to claim 14 wherein the configured data is not modified by the controller before the showing of the graphic information on the display.

19. The method according to claim 14 wherein the graphic information encoded in the configured data represents a state to be assumed for each of a plurality of pixels of the display.

20. The method according to claim 14 wherein several of the configured data are transmitted to the controller sequentially by the safety device, wherein each of the several configured data encodes a different item of the graphic information, wherein each of the graphic information items is shown on the display connected to the controller, and wherein each of the graphic information items uniquely reproduces the configured parameter in a visual, machine-readable manner.

21. The method according to claim 14 wherein several partial information items, each encoding partial information of a graphic information item, are shown sequentially on the display connected to the controller, and wherein a sum of the partial information items uniquely reproduces the configured parameter in a visual, machine-readable manner.

22. The method according to claim 14 wherein the controller receives the configuration parameter by a manual input performed by a person at a human/machine interface.

23. The method according to claim 14 wherein the controller receives the configuration parameter from the mobile, processor-controlled data processing device that is temporarily connected to the controller for data exchange.

24. The method according to claim 14 wherein the controller receives the configuration parameter by retrieving data from a remotely located database.

25. The method according to claim 24 wherein the data in the database was created in a design process and/or during a commissioning of the passenger transport system and either contain the configuration parameter or from which the configuration parameter can be derived.

26. The method according to claim 14 wherein the controller receives the configuration parameter from a data memory coupled to the controller for data exchange.
